(19) United States
(12) Patent Application Publication
(10) Pub. No.: US 2005/0157662 A1
(43) Pub. Date: Jul. 21, 2005

(54) Systems and methods for detecting a compromised network

(76) Inventors: Justin Bingham, Lynnfield, MA (US); Peiter Zatko, Wakefield, MA (US)

Correspondence Address: FISH & NEAVE IP GROUP;ROPES & GRAY LLP, ONE INTERNATIONAL PLACE, BOSTON, MA, 02110-2624, US

(21) Appl. No.: 11/041,772

(22) Filed: Jan. 21, 2005

Related U.S. Application Data
(60) Provisional application No. 60/537,713, filed on Jan. 20, 2004.

(51) Int. Cl. H04L 12/28

(52) U.S. Cl. 370/254

(57) ABSTRACT

Systems and methods are disclosed for monitoring data transmissions on a network and detecting compromised networks. The systems and methods monitor communications involving network hosts and analyze the communications in view of the business function of the hosts. In certain embodiments the analysis is performed by associating a set of rules of operation for the sessions, hosts, and/or environment, and analyzing data packet transmissions to ascertain violations of the rules.

### RELATED APPLICATIONS

This application claims the benefit of U.S. provisional application 60/537,713, filed Jan. 20, 2004, the specification of which is incorporated by reference herein.

### BACKGROUND OF THE INVENTION

Businesses and other organizations use computer networks to transmit and store data and other electronic information pertaining to the organization. The networks are typically formed between electronically connected hosts that are able to transmit information and instructions to and from each other. Exemplary hosts include desktop clients, mail servers, file servers, routers and other hosts or devices that serve particular roles in the organization.

Intruders may be outsiders or insiders. Outsiders, commonly known as “hackers,” attack internal networks at their points of interface with external networks, such as the Internet, which operate in communication with the internal networks. Techniques for hacking a network are known and practiced extensively and are continuously evolving. Some commonly known techniques include remote software exploitation, theft of authentication credentials, and island hopping. Insiders may also do extensive damage and are even more difficult to identify than hackers because they access the network with legitimate (albeit misappropriated or misused) credentials. Insiders are typically either rogue employees or third parties who have stolen valid credentials from an authorized user.

Current network security practices include the use of access control (firewalls, virtual private networks), encryption (document rights management, privacy), intrusion detection systems, and network segmentation. Unfortunately, these practices are less than optimal for detecting attacks by hackers and are even less effective for detecting the activities of malicious insiders or of hackers who access the network through an undetected hack or with legitimate credentials. Most network firewalls and intrusion detection systems are ultimately ineffective in stopping sophisticated hackers, and most detection systems are unable to identify the activities of hackers once they have accessed the network.

Existing intrusion detection systems fall into two categories, host-based and network-based. Host-based systems are installed on every system to be monitored, and keep track of file integrity, odd interactions with the underlying operating system, connections in and out of the host system, and known malicious code that may have been loaded onto the system by a malicious individual. Host-based systems have limited scope since they are confined only to the host they are monitoring and are traditionally very difficult to implement and maintain. No implementation supports a diverse selection of operating system platforms. Furthermore, much configuration and maintenance is required as new software applications are rolled out across the enterprise. The extensive overhead and the ultimate lack of resources to properly maintain these systems results in an large number of false positives/negatives.

Existing network based systems can be further split into the following two categories: signature-based and statistic/flow based.

Signature-based systems look at session packets flowing over the wire in real time and attempt to match the packet payloads with known attack signatures in their vulnerability signature database. These systems are limited in that they only find attacks that match the known attack signatures and will miss attacks that do not. These systems provide limited assistance in detecting intruders who enter a network by a means other than an overt hack. Numerous false negatives are reported under these and other systems, leaving numerous instances of compromise undetected.

Statistical/flow-based systems utilize session summaries, which contain only an abbreviated communication record between hosts, namely that two hosts communicated on particular ports for a given amount of time and exchanged a given amount of data. Based on this information, statistical learning algorithms are applied to create a learned baseline of communication with these abbreviated features. Once the learned baseline is established, any deviation from the baseline is detected and reported. Because these systems rely on limited data transmission information and are equipped with no fundamental rules, they do not provide a sufficiently thorough analysis of the transmissions and are ridden with false positives. They have limited value beyond worm detection and denial of service prevention.

In short, current technology is largely ineffective in detecting compromises on an internal network, particularly those arising from rogue employees and intruders masquerading as authorized users. A recurrent problem with current security systems is the inability to meaningfully reduce false negatives on one hand and to meaningfully distinguish network compromises from false positives on the other. Improved systems are needed.

### SUMMARY

The systems and methods disclosed herein provide for detecting compromised networks. The systems and methods monitor communications involving network hosts and analyze the communications in view of the business function of the hosts. In certain embodiments the analysis is performed by associating a set of rules of operation for the sessions, hosts, and/or environment, and analyzing data packet transmissions to ascertain violations of the rules.

One embodiment includes a method for detecting a compromised host in a network, comprising identifying hosts on a network, identifying model session rules expected to be followed during sessions in which one or more host participates, monitoring data packet transmissions between hosts to identify violations of the model session rules, and identifying a compromise if at least one violation is identified in a session involving a host.

Certain embodiments provide a method for detecting a compromised host in a network, comprising identifying hosts on the network, identifying model host rules of expected operation for one or more hosts within the network, monitoring data packet transmissions involving a host to identify violations of the model host rules, and identifying a compromise if at least one violation of the model host rules is identified.

Certain embodiments provide a method for detecting a compromised host in a network, comprising collecting data packet transmissions involving hosts on the network, identifying model session rules expected to be followed during sessions involving the hosts, for each host identifying model host rules of expected operation for the host and an environment rule for the host, using the data packet transmissions to identify violations of the model session rules, model host rules, and model environment rules, and identifying a compromise if a particular host is involved in one or more rule violations. The rule violations may be of any type (session, host, environment) or combination.

Certain embodiments include providing a report setting forth one or more violations identified through an analysis. In certain embodiments the report may provide a score for each violation.

In certain embodiments the systems and methods allow for the detection of a host changing roles on a network, hosts participating in one or more mirrored sessions, and other activities indicative of a compromise.

In certain embodiments the systems and methods are applicable to servers, clients, and/or network devices. In certain embodiments the systems and methods allow for the detection of activities by malicious insider, particularly insiders who have gained unauthorized access to the network.

Certain embodiments provide for further monitoring of data packets sent and data packets received by a host through the network after identifying the host as compromised.

In certain embodiments, network transmissions are monitored through a single source applied to the network. In certain embodiments the systems include a data gathering unit positioned at a single source on the network. In certain embodiments monitoring data packet transmissions includes using a tap or span port to copy data packets transmitted on the network, bundling the copied data packets into groups based on the network protocol identified in the data packet headers, associating the data packets in the groups according to unique sessions in which the data packets were transmitted. In certain embodiments, the data may be compiled into a profile of session information for each host on the network based on the data packets transmitted in the sessions.

In another aspect, the systems and methods provide for reducing false positive results when identifying a network compromise, comprising monitoring data packet transmissions between hosts on a network, identifying model session rules expected to be followed during sessions involving the hosts, associating a model host having rules of expected operation for the hosts, using the data packet transmissions to identify violations of the model session rules, using the data packet transmissions to identify violations of the model host rules, and identifying a compromise if a particular host is involved in one or more rule violations. The rule violations may be session rule violations, host rule violations, combinations of both.

The systems and methods also provide for applying a model environment rule for each host and using the data packet transmissions to identify violations by the host of its model environment rule. A compromise may be identified if a particular host is involved in a rule-violating session and operates either in violation of a host rule or in violation of its environment rule.

Methods and systems are also provided for reducing false positive results when identifying a network compromise, comprising monitoring data packet transmissions between hosts on a network, identifying model session rules expected to be followed during sessions involving the hosts, model host rules of expected operation for the hosts, and a model environment rule for each host, using the data packet transmissions to identify violations of the model session rules, using the data packet transmissions to identify violations of the model host rules, using the data packet transmissions to identify violations by one or more hosts of their respective model environment rule, using the data packet transmissions to identify instances where a host engages in communication typical of an intruder, and identifying a compromise with reduced false positive results if a particular host is involved in one or more rule-violations. As noted, the rule violations may be session rule violations, host rule violations, environment rule violations. The host may also be participating in other communication typical of an intruder, which may be noted and included in the analysis.

In certain embodiments the other communication typical of an intruder includes one or more of: IRC Traffic, ICMP Routing, IDS Evasion and software known to be used by malicious users.

In another aspect, the methods and systems allow for conducting validation studies to reduce one or more false positives, to identify one or more false negatives, or instances of both.

In another aspect, the systems and methods allow for the detection of a location of compromise on a network. The network may be repaired by identifying a compromised host by the methods and systems described herein, stopping network traffic in and out of the compromised host, and allowing all uncompromised hosts on the network to continue functioning without interruption.

In another aspect, a method is provided for validating a detected compromise on a network, comprising identifying a host involved in a session that violates a model session rule, identifying model host rules of expected operation for the host, analyzing the data packet transmissions involving the host to identify violations of the model host rules, and validating an identified compromise if at least one violation of the model host rules is identified. Such validation techniques may also include identifying a host involved in a session that violates a model session rule, identifying a model environment rule for the host, analyzing the data packet transmissions involving the host to identify violations of the model environment rule, and validating an identified compromise if at least one violation of the model environment rule is identified. Other validation techniques may be applied to further ascertain network compromises.

Those skilled in the art will appreciate that systems may be fashioned for detecting a compromised network, comprising a data monitoring device adapted to collect data packet transmissions on a network, software programmed with model session rules expected to be followed during sessions involving hosts on the network and with rules for operation of a model host expected to be followed by one or more hosts on the network, and a data analysis engine operably connected to the data monitoring device and the software, and adapted to analyze the data packet transmissions to identify a network host participating in a session with one or more session rule violations. The systems may also be adapted so the data analysis engine can analyze the data packet transmissions to identify a network host violating at least one rule of operation of a model host. The system software may be programmed with a model environment rule for each host, and the data analysis engine is adapted to analyze the data packet transmissions to identify a host operating in violation of its model environment rule.

A reporting unit may also be provided, as further described herein.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE FIGURES

The systems and methods may be better understood and their numerous features and advantages made apparent to those skilled in the art by referencing the accompanying figures.

FIG. 1 is a high-level schematic of a compromised network.

FIG. 1A depicts a compromise detection system connected to a network.

FIG. 2 depicts an embodiment of a method for detecting a compromise in a network.

FIG. 3 illustrates an exemplary session analysis.

FIG. 4 depicts an exemplary host analysis.

FIG. 5 depicts a mirrored session.

FIG. 6 is a summary chart reporting session and host rule violations found in a network analyzed according to the systems and methods disclosed herein.

FIG. 7 depicts an embodiment of a method for detecting a compromise through a session analysis and applying a host analysis to suspect hosts identified in the session analysis.

FIG. 8 depicts a mechanism for calculating a score for results of an analysis of a network performed according to the systems and methods disclosed herein.

The use of the same reference symbols in different drawings indicates similar or identical items.

### DETAILED DESCRIPTION OF CERTAIN EMBODIMENTS

Disclosed herein are systems and methods monitoring and analyzing network traffic, particularly traffic on internal networks. Internal networks include networks that are operated under the supervision of a limited number of network administrators, typically one administrator. Such networks are vulnerable to compromise by intruders. Intruders typically exploit a network by a four step process—infiltration (gaining access), reconnaissance (gathering credentials to access protected hosts), establishing residency (e.g., by establishing a reverse tunnel), and taking unauthorized action (e.g., stealing data, disrupting the network). The invention is directed to systems and methods for identifying a compromise in a network by identifying the activities of an intruder in one or more of the stages of compromise, and may be more fully appreciated by reference to the figures and examples provided herein. However, the figures and examples are provided for purposes of illustrating the invention and are not exhaust or to be understood as limiting the scope of the invention.

The systems and methods described herein provide for detecting when an intruder has compromised the security of a network and is presently acting within the network to copy data, monitor communications, interfere with system operation, or to perform some other malicious or clandestine activity. As will be described in more detail hereinafter, the system methods, in one embodiment, operate as an off-line system capable of collecting the data transmissions that have occurred across a network, or at least a portion of a network. The data transmissions can be analyzed to determine the behavior of the network, including performing an analysis of the operating characteristics of different data transmissions over the network, and performing an analysis of sessions that occur between different, clients and servers, routers and other hosts, or other devices or entities on the network.

In one particular embodiment, the system stores the data packet transmissions that occurred over that network for a particular period of time. The system will then index the different data packets according to sessions between hosts on the network. The system may also index the data packets on a host by host basis according to whether data was sent or received in sessions by each host. Thus in the data collections stage, the system stores the data packets occurring over the network and indexes the data packets to different hosts and sessions. This provides the system with an actual depiction of how hosts are behaving and a representation of the sessions that have occurred on the network.

This representation of the actual behavior of the network may be passed to an analysis engine. The analysis engine may have a set of the rules representative of model session performance, model host performance, and model environment performance for an uncompromised network. The model session rules may be used by the analysis engine in a first step that analyzes the data of the actual behavior of the network to identify session rule violations and to identify hosts involved in these violations. The model host rules may be used by the analysis engine in an independent step that analyzes the data of the actual behavior of the network to identify host rule violations. The model environment rules may be independently applied to identify violations involving multiple hosts. Thus by comparing the actual network activity associated with network hosts, the system may identify sessions, hosts, and host combinations that are behaving in a manner outside the expected rules of behavior for the network.

The hosts involved in a session, host or environment rule violation may be reported and in a second level of analysis the data associated with these hosts may be analyzed by comparing the actual behavior of a host with a set of rules for the expected performance of each host on the network.

The information generated by the analysis engine may be provided to a network administrator or another responsible party for the purpose of identifying possible compromises occurring on the network. In one embodiment the system will report the hosts that were involved in violations, typically when the violations were significant enough from the expected behavior as to warrant reporting. Similarly, the system may provide a score based for example on a number of violations awarded to a session, host, or combination of hosts to indicate the likelihood that a given host is compromised, or at least functioning in a manner that suggests an intruder has gained control of the host.

Variations and modifications can be made to the systems and methods described herein without departing from the scope of the invention. For example, the systems and methods described herein are largely, although not exclusively, described as off-line systems capable of performing an off-line analysis of the behavior of different hosts on the network to identify activity representative of a compromised host. However, in other embodiments and practices, the system may perform a real time analysis of the behavior of a host, or set of hosts, on the network as well as a session or a set of sessions on the network to determine whether a compromise has occurred. This and other variations and modifications may be made to the systems and methods described and all such modifications and variations fall within the scope of the invention.

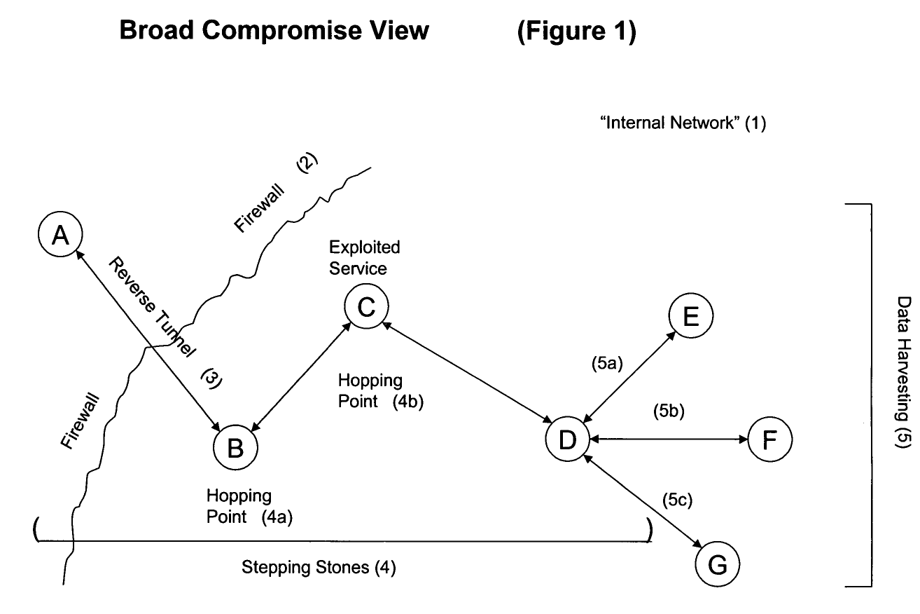

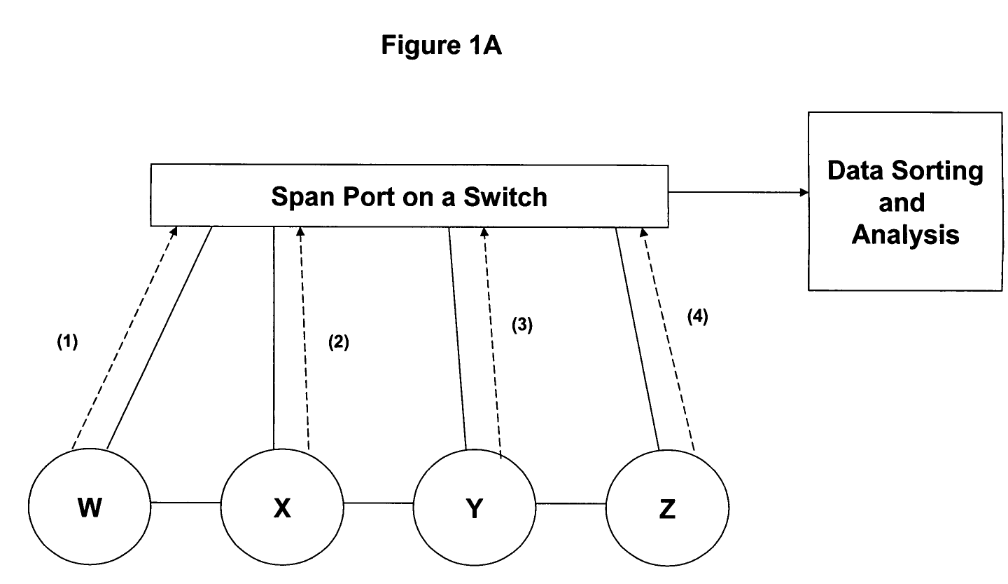

FIG. 1 depicts an example of a computer network or data network that has been compromised such than an intruder has gained access to at least one node or host on that network and is capable of exploiting that access for the purpose of monitoring data transmissions on the network or for interfering with the operation of a host or a series of hosts on that network. More particularly, FIG. 1 depicts an internal network (1), a firewall (2), and a set of Hosts A through G As further depicted by FIG. 1, the host A is outside of the firewall (2) and the Hosts B through G are protected by the firewall (2). FIG. 1 depicts that an Intruder at Host A or in control of Host A has gained access to Host B through an unauthorized means (e.g., through the misappropriation of legitimate credentials, not shown) and has a reverse tunnel connection with Host B. Such a tunnel may be established if, upon gaining access, Host A commands Host B to transmit connection signals to the external environment, and A thereafter receives the signals from outside the network and connects to Host B to initiate the tunnel.

Referring further to FIG. 1, Hosts A through D act as stepping stones that allow the intruder to use Host A to collect information from Hosts E, F and G. As such, FIG. 1 depicts a network (1) that has been compromised by an intruder that has used external Host A to create a reverse tunnel to Host B. From Host B, various hopping points have been identified by the intruder so that the intruder can collect information from Hosts E through G. The systems and methods described herein provide a detection process that allows a network administrator to monitor the data packet transmissions occurring over the internal network (1) and to analyze those transmissions to determine behaviors and activities for the hosts in the internal network (1) that will indicate whether an intruder has penetrated the internal network (1).

The system is adapted to monitor and analyze data packet transmissions from one host to another on a network. In one embodiment the system includes one or more network taps or span ports connected to the network with a cable through which they monitor and copy the data packets flowing in and out of each host. The system may be adapted to monitor communications between network hosts and hosts external to the network. The taps or span ports may comprise hardware or software devices, but either way they can monitor and/or record the relevant data packets.

Data packets include multiple layers of information that signal characteristics about the packets, such as the size of a data packet, the time the packet is sent, the source of the sender (both the hardware address and the network IP address), the source of the destination (both the hardware and network IP addresses of the recipient), the payload (number of bytes transmitted), the application protocol of the transmission, the statistical content of the transmission (format of the command text, such as HTML), and other characteristics. The packets may be processed in batch or in real-time. In certain embodiments the data packets are recorded in subsets of a specified memory size, such as 512 MB, and prepared for further organization and analysis (as described further below).

FIG. 1A depicts an embodiment of a system for monitoring and analyzing data packet transmissions on a network according to the invention. Depicted is a network (1A) having hosts W, X, Y, and Z in communication one with another. Also depicted is a span port on a switch affixed to the network in direct communication with hosts W through Z. Also depicted are lines 1 through 4 each of which indicates the flow of a copy of data packets that are transmitted in and out of the respective hosts. More particularly, data packet transmissions in and out of host W are copied by the span port as indicated by dotted line number 1. Similarly data transmissions in and out of host X are copied to the span port as indicated in line 2, etc. Also indicated in FIG. 1A is a data sorting and analysis component. After data packet transmissions involving each host are copied to the span port they are transmitted to the data sorting and analysis section for further manipulation and analysis as more fully described below. Once collected, the data may be organized as desired.

In certain embodiments, the data may be sorted according to unique network sessions. In a first step according to such embodiments, the data may be bundled into subgroups according to the type of session, also known as the network protocol, in which the packet is transmitted. Typical network protocols include, but are not limited to Ethernet, IP, ICMP, TCP and UDP. Other network protocols may also be identified and used as a basis for bundling, and are not outside the scope of the invention. The session type is typically identified in the data packet headers, and the system is adapted to read the session type therefrom and group the packets accordingly. For example, the data packets transmitted during IP sessions reveal through their headers that they are associated with IP protocols. All data packets having such IP protocol notification in the headers may be combined into a single subgroup. All ICMP data packets may be similarly identified and combined, etc. Some data packets may have multiple layers with multiple protocols. Each packet may be copied and included with all applicable groups. For example a packet may contain an Ethernet header and payload, IP header and payload, and TCP header and payload. In such case the packet may be copied and bundled with Ethernet session types, IP session types, and TCP session types.

In a second step according to such embodiments, the system further sorts the data in the subgroups by associating each data packet in the data subgroups with its particular hosts and transmission session. This may be done by associating a packet with the sending and receiving hosts' addresses, with the time stamp, and/or with other characteristics as needed to uniquely identify the session.

Once the data packets are associated with unique sessions, the system may generate a profile of information particular to the session. The session information may include, for example, the following:
the identity of hosts on the network
the identity of the initiator of a session
the identity of the data producer and consumer of a session
the operating system generating a session
interactivity in a session
application protocol of a session (including signature fingerprint, and statistical fingerprint)
statistical content (format of the command text, such as HTML)
the IP addresses of the host pair involved
the hardware addresses of the host pair involved
the time that each session between hosts starts and stops, session duration
data integrity (checksums, fragmentation, options)
   The system may further organize the data as desired. In certain embodiments the session information may be organized on a single-host basis according to all of the transmissions involving a given host. Other methods of sorting and organizing the data are also possible, and the foregoing is intended only for illustration. The system may also store the session information.

Once collected and organized, the session information may be analyzed by applying rules of operation that govern communications on the network. The rules, in one embodiment, are based on the identified principles that: (1) hosts (e.g., B-G) are programmed to serve the goals of the business or other organization that operates the network, (2) the operating characteristics of a network host stay relatively constant over time, and (3) hosts conduct efficient communications on a network. Other principles may include that servers do not spontaneously behave like clients, and clients do not spontaneously behave like servers. Servers typically receive instructions from clients and respond in accordance with the instructions. Clients do not spontaneously behave like proxies, and servers do not spontaneously behave like gateways.

The foregoing exemplary principles may be embodied in rules that may be imported into a software analysis routine. Such rules may be characterized as model session rules for how sessions are typically conducted or expected to be conducted amongst hosts based on the hosts' pre-assigned port numbers or other identifiers (“model session rules”), rules for how a given host behaves (“model host rules”) in the sessions it participates in, and rules for how hosts interact with other hosts in the network (“environmental rules”). These rules will apply irrespective of the type of business or other organization that operates the network.

Session Rules

A session analysis involves identifying model session rules and analyzing data from network sessions to identify violations of the rules. The model session rules are based on the application protocol (e.g., the port number) of the particular hosts being monitored. The system identifies the application protocol from the data packet headers and implies a set of session rules for sessions involving the host. Thus, a host on web server port 80 would be expected to exhibit similar session information from one session to another, and even from one organization to another. The model session rules in one embodiment may include:

1. The Length of a Session is Usually Consistent from One Session to Another for a Given Application Protocol.

As with other features, session lengths remain relatively constant across instantiations of an application protocol. The period length is determined by subtracting the session end time from the session start time. Sessions for a given application may be short or long or of some fixed duration but, in any event, will be suited to the application protocol. Sessions with significant time durations are typically large data transfers (non-interactive), or involve interactive control channels such as telnet, ssh, etc. The allowed threshold period depends on the application protocol running on the hosts. The threshold time period may be set at any level from seconds, to minutes, may be any time period (e.g. 6 hours, 1 day).

2. Interactivity: A Session on a Port having a Non-Interactive Protocol should not Become Interactive.

As with other features, session interactivity remains relatively constant across instantiations of an application protocol. Certain protocols call for non-interactive traffic, others may provide for interactivity. Interactivity occurs when a human, rather than a server or other network device communicates with or even controls communications with a host. Interactive sessions are often marked by the transmission of slow, short data packets that are separated by measurable time differences. Non-interactive sessions typically occur between machines, where one machine submits a request to another and the other promptly acts on the request. Data packet transmissions are typically large, fast, and closely separated in non-interactive sessions. Where a protocol stipulates non-interactive traffic, and interactivity is found in a session using that protocol, a violation may be reported.

3. Initiation Reverse: a Host Will Initiate a Session Only if Provided for in the Application Protocol Running on the Host.

As with other features, session initiation sources remain relatively constant across instantiations of an application protocol. In many protocols, such as HTTP, servers do not initiate sessions with clients. A given host is typically either a client or a server, and the applicable protocol is established with the host when it is placed on the network.

4. Data-Flow Reverse: a Host Will Serve Data to Another Host in a Session Only If Provided for in the Application Protocol Running on the Host.

As with other features, data flow direction remains relatively constant across instantiations of an application protocol. A violation of the rule is identified by comparing the amount of data produced during a session by hosts having server application protocols as compared to the amount of data produced by hosts having client protocols during the session. A ratio is calculated including bytes produced/consumed, and compared to a pre-determined value for the particular hosts involved. The comparison value may be pre-determined based on the application protocol running on the hosts. In many protocols, servers produce data and clients consume the data, and not the reverse.

5. Sessions Occurring Between Hosts have Identifiable and Established Signature Patterns Based on the Application Protocol.

As with other features, signature patterns remain relatively constant across instantiations of an application protocol. Signature patterns may be identified in the data packets and include, for example, signal commands such as GET, POST, PUT for Http. Violation occurs if unexpected signal commands are included in a transmission, as compared to commands expected to be included based on the application protocol.

6. Sessions Occurring Between Hosts have Identifiable and Established Statistical Content Based on the Application Protocol.

As with other features, statistical profiles remain relatively constant across instantiations of an application protocol. Where a transmission occurs on port 80, the statistical content would be expected to be html. If the actual statistical content of a port 80 session is English command text, then a violation has occurred.

In certain embodiments, the system is adaptable to monitor communications on a network and identify and report violations of one or more session rules. Certain compromises will not necessarily result in a violation of all of the rules (in some cases none of the rules will be violated). In certain embodiments, a compromise may be identified where a sufficient number of violations of the rules occur during a session. In certain embodiments a threshold number of violations may be identified and reported and a compromise found where the number exceeds the threshold.

Host Rules

Exemplary rules applicable to network hosts include:

(1) A Given Host's Role on a Network is Singular and Static.
A given host typically serves only one role (e.g., client, server, gateway). Compromised hosts often begin to behave in multiple roles. By analyzing the data packet transmissions it can be readily shown whether a particular host is functioning in more than one role. For example, clients typically do not serve applications.

(2) A Given Host is Involved in Sessions having Characteristics that are Consistent for a Given Application being Run on the Host.
Hosts tend to have consistent sessions where a particular application is involved. Some server hosts serve up multiple applications. With respect to a particular application, the system will identify sessions with characteristics that are inconsistent when compared to other sessions involving the particular application.

(3) Hosts do not Download Extensive Data from Multiple Servers.

For a given network, the amount of data typically downloaded by a host is limited based on the amount of data retrieved and the number of servers from which the data is retrieved. For example, most hosts do not download data from web server, FTP server and file server.

Violations of any of the foregoing may be indicative of a host or network application on a host changing its role on the network, such as a client functioning as both a client and a server, or a mail server sporadically behaving like telnet. Changes in a host's function may be identified in this manner, and instances are reported when the host or application on the host functions in more than one role.

Environment Rule

Interactions among network hosts typically behave according to the rule that:
the communication pathways between hosts remain fairly fixed and static.
   While a host may communicate with a variable number of hosts, the communication pathways between the hosts do not typically change. A given host's communication pathways comprise a profile, and a host that operates outside its profile violates its environment rule.

For example, clients are typically set up to route through one or more particular gateways, and they do not change gateways spontaneously. If a host begins routing traffic through a new gateway then it does so in violation of its environment rule. Similarly, network hosts tend to use specific intermediate hosts (such as proxies) but do not spontaneously use non-proxy hosts as intermediates. In contrast, intruders often need to use intermediates, known as hopping points, to gain access to network hosts because they lack the appropriate credentials to access the desired hosts. As noted above, the intruder at Host A can access the credentials to Host D by connecting with Host C, but had no way of gaining direct access to Host D. The data transmissions involving Host B may reveal whether B is functioning through intermediate hosts on the network. Host C is an SMTP host, not a proxy. The use of Host C as a proxy is a violation of Host C's environment rule. These examples are merely illustrative of how a communication profile could change.

Modus Operandii

The systems and methods may also be adapted to identify other intruder behavior through analyzing the data packet transmissions. For example, hacker intruders often connect to Internet chat rooms (such as IRC) from a compromised network to chat about or even boast in their successful hack. This type of activity can be identified by identifying external, interactive sessions established by network hosts using the IRC protocol. While such activity may not be identified as a session or host rule violation (clients are programmed and expected, at least on occasion, to engage in such activity), it provides additional insight during a compromise analysis as described above. Accordingly, the systems and methods may be adapted to identify behavior indicative of an intruder, known as “Modus Operandii”, and to combine them with identified rule violations to identify a compromise.

The instances of Modus Operandii are as varied as the number of intruders. Certain examples are listed in Table 3.

| | |
|---|---|
| TRC Traffic | Connection to JRC server, often utilized by |
| | hackers to brag about the network they |
| | accessed |
| ICMP Routing | Technique used to alter routing patterns, not |
| | commonly used for any valid purposes |
| IDS Evasion | Techniques used to evade detection by |
| | conventional (network/host-based) ids systems |
| Known malicious | Signatures of known malicious software (e.g. |
| software | Back Orifice, Sub7) |
| Common attack/ | Port scanning, Port bouncing |
| reconnaissance | |
| techniques | |

Those skilled in the art will recognize that the collected data packet transmissions could be analyzed to identify any type of behavior indicative of a hack or compromise, not limited to those behaviors identified above.

The systems and methods described herein may be applied and adapted in a variety of ways. In one aspect, the systems and methods are useful troubleshooting a network, allowing an administrator to identify a point of compromise in a network. Network traffic through the compromised host can be stopped while still allowing uncompromised hosts on the network to continue functioning without interruption. Further applications and embodiments are possible, as may more fully be seen in the following examples and further explication.

The methods and systems may be better understood by reference to the following examples, each of which is intended for mere illustration and does not limit the scope of the invention. The systems and methods allow for independent analysis of each level of network performance—session analysis (Level 1), host analysis (Level 2), and environment analysis (Level 3). In addition, the systems and methods are adapted to identify other activities occurring on a network that are not necessarily violations of network rules but are indicative of an intruder. Such activities, known as “Modus Operandii” may be included in the analysis. As described in more detail below, in certain embodiments the analysis applied to a network is made to identify violations of the rules, and a score is given to identified violations. The score may be reported to network administrators or other appropriate persons for assessing whether a network is compromised.

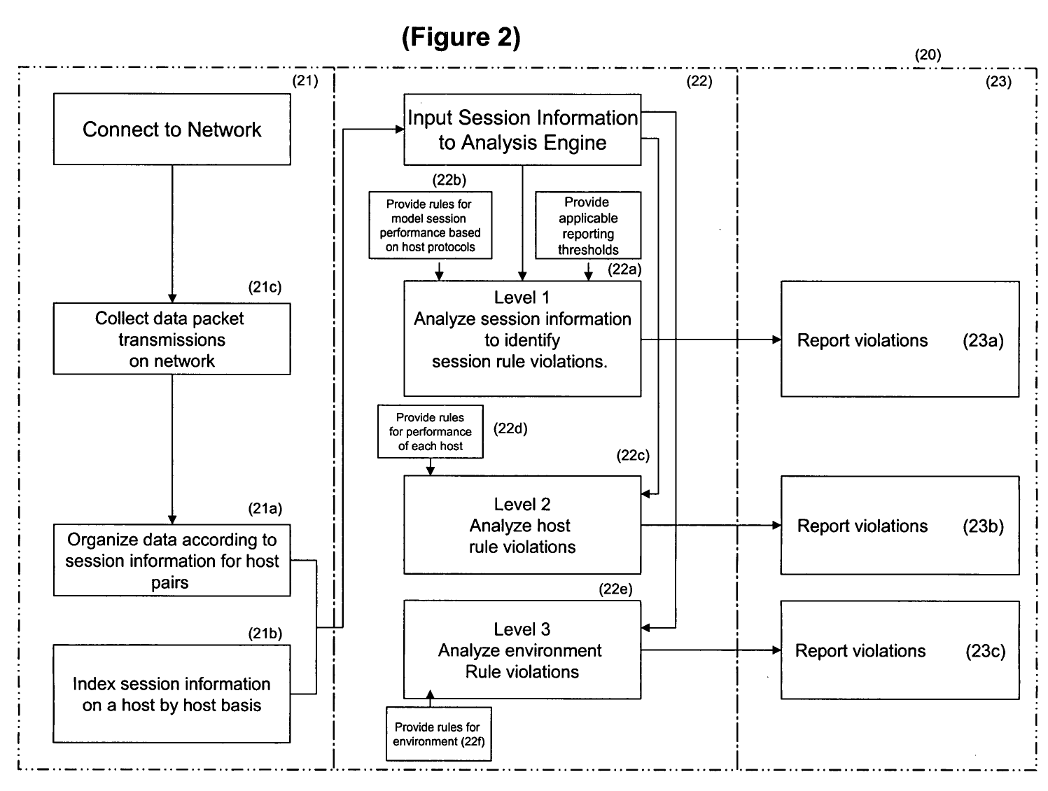

FIG. 2 is a flow chart that depicts a process for applying the systems and methods described herein. The process includes an initial phase of connecting a software and analytical system (20) to a network, such as network (1). The system (20) includes a data gathering unit (21), for monitoring and sorting data packet transmissions over the network into session information, an analysis engine (22) for analyzing session information to identify rules violations, and a reporting unit (23).

Considering the steps of FIG. 2 individually, the data gathering unit (21) copies the data packet transmissions that occur over the network, typically through one or more taps or span ports. Data packets include information such as the size of the data packet, the time the packet is sent, the source of the sender (both the hardware address and the network IP address), the source of the destination (both the hardware and network IP addresses of the recipient), the payload (number of bytes transmitted), and the data integrity. As shown in FIG. 2, the data packets may be sorted into session information on a host-pair basis (21a), as described above. In FIG. 2, the session information is further organized on a single-host basis (21b) according to all sessions involving each host. Data organized on a host-pair basis provides additional data particular to sessions occurring on the network (1). After collecting and sorting data according to the foregoing, a network, such as network (1), may be analyzed for rule violations. Referring further to FIG. 2, the session information may be input to a data analysis engine (22) and analyzed on one or more levels.

Session Analysis

As noted, the analysis may be performed by identifying session information and comparing it to characteristics that would be expected of hosts on ports corresponding to the ports on the network. As shown in FIG. 2, session information may be sent to the session analysis unit (22a) and analyzed for violations of session rules (22b). For example, the process of FIG. 2 may be applied to gather data packet transmissions on network (1), prepare session information as described above, and analyze sessions involving Hosts B-G.

The session analysis is illustrated by focusing on the sessions in isolation. While the systems and methods can be applied to isolated sessions, in certain embodiments, the results of analysis of each host's sessions are combined to provide an overall compromise analysis for the system.

Certain examples are derived from FIG. 1 and are illustrated below.

Session A <-> B

As shown in FIG. 1, the intruder at Host A has gained access to the network (1) through Host B. This compromise can be detected using the systems and methods by analyzing the session(s) between Host A and Host B and identifying violations of session rules. In this case, several session rule violations may be seen, as shown in Table 1:

TABLE 2

| | | |
|---|---|---|
| Session Characteristic | Time Duration: | Too Long |
| Violations: | Data Flow: | Reversed |
| | Interactivity: | Interactive over Non- |
| | | Interactive Protocol |
| | Application Protocol: | Unknown over known |
| | | Protocol |
| | Statistical Content: | English Command Text, |
| | | expected HTML |

As noted, the session between Host A and Host B is longer than a threshold time applicable to the Host B protocol (which may be several minutes). The data flow is also reversed in that Host A, which is operating on Port 80, is sending data (e.g., commands to steal data from the network) to Host B. Typical hosts operating on Port 80 are web servers that receive data. Furthermore, in this case Host B is a client but is consuming data from Host A. The data flow may be measured by comparing the ratio of data produced/consumed by Host B in the session with Host A to a pre-determined value based on the application protocol running on a particular, Host A in this case.

The session is also interactive, whereas HTTP traffic (the implied protocol for Host B) is non-interactive. An interactive session may be identified by correlating the transmission frequency of consecutive small packets (e.g., less than about 20 bytes) during the session with the inter-arrival period (which is the period that passes between a host's sending of consecutive data packets). As noted by Zhang and Paxson (“Detecting Backdoors” www.icir.org/vern/papers/backdoor/index.html), this may be determined as follows:
the packet size frequency (T)=(S−G−1)/N, where S is the number of small packets transmitted, N is the total number of packets, and G is the number of instances when a large packet is transmitted in between two small packets, and
the consecutive small packet timing ratio (Y)=Q/N, where N is the number of back to back small packet transmissions, and Q is the number of back to back small packet transmissions that occur within a specified time range (e.g., 0.2 msec and 2 sec).
   Each of these equations may include a control parameter (e.g., >0.2), and would not give rise to a violation if the parameter is not exceeded. Although typical network traffic is non-interactive, a variety of circumstances occur where this notion does not hold true. For example, sessions may become interactive in the event a customer running AOL instant messenger using port 80 because firewall blocks port typically used. An analysis of interactivity alone then, without further confirmation or other types of analysis, may give rise to false positives.

Referring back to Table 1, session A<-> B also features an unknown application protocol of the session (whereas application protocols for host B is typically known and identifiable in the data packet transmissions involving the host). Statistically, the session occurs using English command text, rather than HTML. The session between Host A and Host B also features a flow of information from B to A, rather than The information identified in Table 1 may be reported, as shown in FIG. 2, to the reporting unit (23a).

Session B <-> C

Turning again to FIG. 1, the session between Host B and Host C may be analyzed according to the systems and methods. In this example, the session B<->C shows the violations of session rules in Table 2:

TABLE 3

| | | |
|---|---|---|
| Session B<->C | Time Duration: | Too Long |
| Characteristic | Interactivity: | Interactive over Non- |
| Violations: | | Interactive Protocol |
| | Application Protocol: | Unknown over known |
| | | Protocol |
| | Statistical Content: | English Command Text, |
| | | Expected ASCIJIBinary |
| | | mix |

As noted in the table, the session between Host B and Host C is longer than a threshold time applicable for hosts of this port on network (1). The session is interactive, whereas the protocol for Host C (SMTP, the implied protocol) is to participate in non-interactive sessions; the application protocol of the session is unknown, whereas application protocols for SMTP is identifiable in the data packet transmissions involving the hosts. Similarly, the session occurs using English command text, rather than a Binary/ASCII mix, as may be expected of hosts such as these. The information identified in Table 2 may be reported 23(a), as shown in FIG. 2, through the reporting unit (23). The information may also be further analyzed through validation (see below) to confirm or negate the findings.

The session analysis may be adjusted to provide desired sensitivity. In the above examples, four rule violations are reported. In certain embodiments, the session analysis unit (22a) is programmable to report violations only if a threshold number are seen in a given session. For example, the threshold may be set so that a session is not reported as a violating session unless more than one rule violation is found in the session. The session analysis may also be set to report all violations to the host analysis component (22c) for validation but report to the user (23) only instances where the threshold is met. In any event, when a reportable violation is identified, the session is reported for output (23a) and/or further analyzed through validation (see below) to confirm or negate the findings.

Host Analysis

The host analysis may be applied independent of the session analysis. As shown in FIG. 2, the session information is transferred to the host analysis component (22c) where it is analyzed to identify violations of host rules (22d).

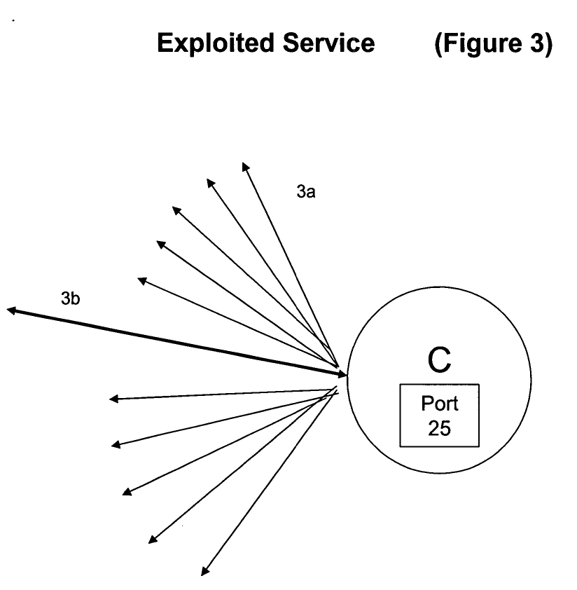

The host analysis may be illustrated as shown in FIG. 3, which shows Host C on Port 25 (SMTP mail server), and arrowed-lines extending away from Host C. The arrowed lines represent sessions involving the Host and other hosts through the use of a particular application running on the Host. Among the arrowed-lines, lines 3a represent sessions between Host C and other hosts, and line 3b represents the session between Host B and Host C referenced above involving Application 3X. Host C may have multiple applications running but only those involving Application A are shown. As shown in FIG. 3, line 3b is drawn longer and darker, and is bilateral, all reflective of its having different session characteristics compared to the other sessions running Application A. In this example, while other sessions involving Host C are typically non-interactive, are of a short duration, involve SMTP application protocol, and feature binary/ascii data, session 3b is much longer, is interactive, is of unknown application protocol, and features command text rather than binary/ascii data (statistical content). Each of these occurrences is identified as a violation of a host rule.

In another aspect, the direction of client-server data flow, as described above for session level analysis, may be applied at the host level. Data flow in each session involving Host C and Application X is monitored and analyzed. If one or more sessions with aberrant data flow are identified with respect to Host C then a host rule violation is noted.

In another aspect, the hosts of FIG. 1 may be analyzed to identify extensive data downloading. Typical network hosts, when uncompromised, do not need to download data from multiple sources. Data downloading coordinated from among more than one server would be identified through the methods as a violation. As shown in FIG. 1, Host D is engaged in long sessions with hosts E-G, and in each case D is extracting data of a size that exceeds a specified threshold limit. This would be considered an environmental rule violation for Host D.

Results of the host analysis may be reported to the reporting unit (23b) and reported to a network administrator or another responsible party to identify possible compromises.

Environment Analysis

The environment analysis may be applied independent of the session or host analyses. As shown in FIG. 2, collected data may be sent to the environment analysis unit (22e) and analyzed for violations of the environment rules (22f) applicable to the hosts. The results may be reported (23c) to network administrators or other appropriate persons to assist in identifying compromises.

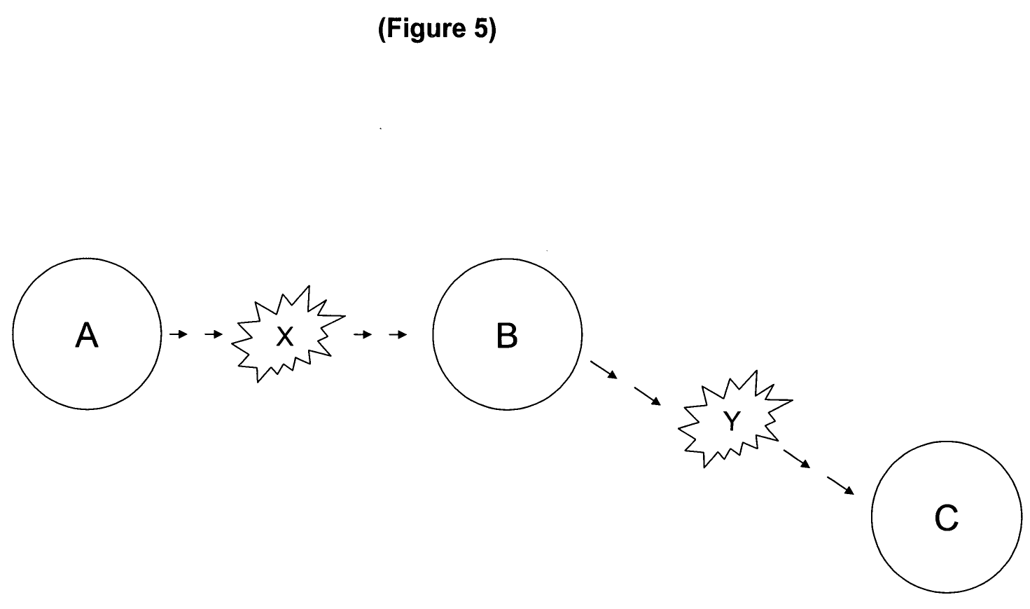

FIG. 5 illustrates the application of environment analysis, as applied to combinations of hosts on a network. As noted in FIG. 1, a hopping point (e.g., Host B) is being used to facilitate transmission from Host A to Host C. Host A sends request (x) to Host B, and Host B sends the same request (y) to Host C. This type of activity may be identified by analyzing “on/off periods” of transmissions between the two hosts. As noted by Zhang and Paxson (“Detecting Stepping Stones”, www.icir.org/vern/papers/stepping/index.html), the time period that elapses between when transmission (x) to Host B ends and when transmission (y) from Host B to Host C ends indicates that the transmission to B was merely relayed from B to C. This may be correlated with the number of periods when each connection (A-B and B-C) is idle, each period known as an “OFF” period. As described by Zhang, an algorithm may be adopted to test isolated transmissions of this sort for stepping stones, as follows:
Transmission A-B is correlated with Transmission B-C if the ending times differ by ≦δ, where δ is a control parameter, and
For Transmission A-B and Transmission B-C, let OFFAB and OFFBC be the number of OFF periods in each transmission, and OFFAB/BC bet the number of the OFF periods that are correlated (per above).

B is considered a stepping stone between A and C if:
(OFFAB/BC)/min(OFFAB, OFFBC)≧γ, where γ is a control parameter (set to 0.3 in certain embodiments)

The control parameters may be established by a user as appropriate for a given network.

While the system disclosed herein may be implemented to analyze the session information at the session level, host level, and environment level in an independent fashion, the system may also be adapted to conduct analysis on a combination of levels, and even to combine the results of each analysis level to provide an overall analysis of a network. In certain embodiments host level and environment level analysis may be performed. In certain embodiments Session Level and Environment or Host Level analysis may be performed. In certain embodiments the combined layers of analysis are applied to reduce false negatives and/or false positives.

In one aspect, the system may be applied in combination to further confirm whether reported violations from a particular analysis level are a result of a compromised network.

In certain embodiments, the host analysis described above may be applied_to confirm whether a reported session violation arises from a compromise or is a false positive. In certain embodiments the environment analysis may be applied to confirm whether a host or session level analysis result indicates a compromise.

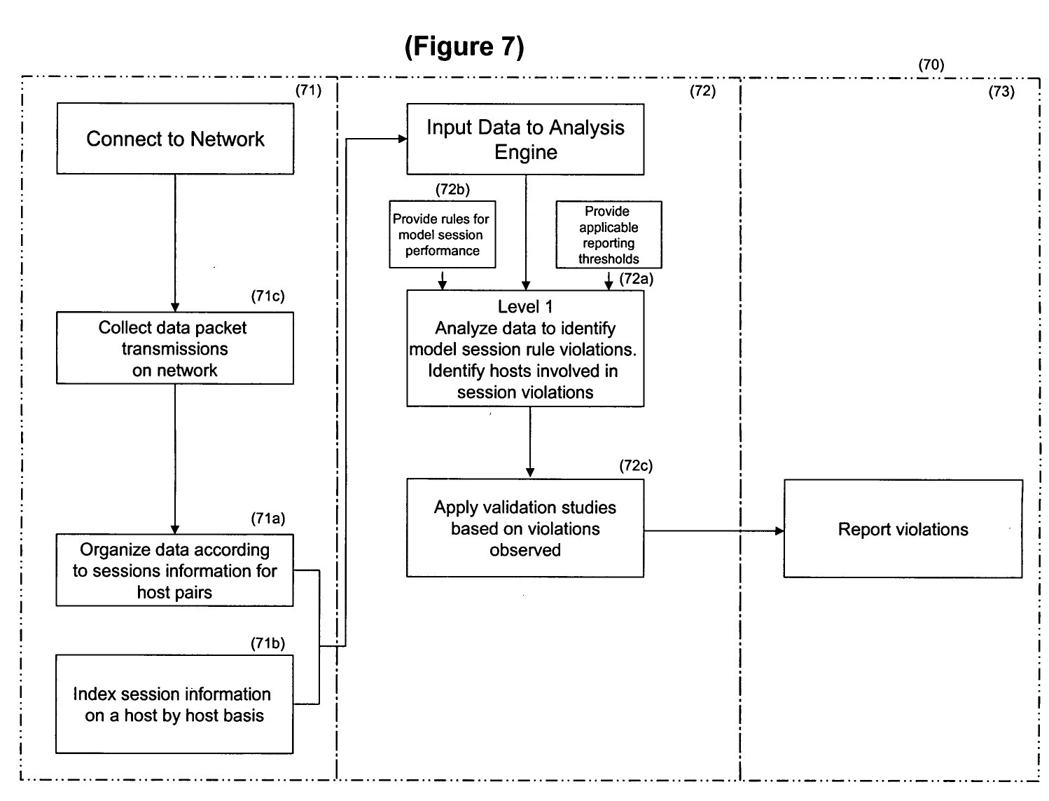

FIG. 7 depicts an exemplary process for combining levels of analysis to identify network compromises. It includes an initial phase of connecting a software and analytical system (70) to a network, such as network (1), it also includes a step of gathering data packet transmissions through a data gathering unit (71), for monitoring and sorting data packet transmissions over the network and identifying session information. FIG. 7 also depicts the use of an analysis engine (72) for analyzing the session information to identify rules violations, and reporting the violations to unit (73). In the depicted embodiment of FIG. 7, the session information is analyzed (72a) to identify sessions involved in multiple violations of the model session rules (72b). Prior to reporting to the reporting unit, the data are analyzed by validation studies (72c) for the purpose of negating false positives and identifying further instances that may be indicative of a compromise (exposing false negatives). After such studies, a report is sent to the reporting unit (73) noting the particular hosts that continue to be (or are discovered through validation as being) involved in violating session rules, host rules, etc.

In certain embodiments, this analysis is applied to the particular identified host(s) by applying host rules as described above. In one aspect, the host rules may be applied to sessions involving particular applications being run on a server to compare a first session involving the host at issue and other sessions involving the host to identify differences in the characteristics of the sessions.

For example, an application on a server typically receives instructions from another computer (not from a client), typically does not initiate communication with another host, and typically contains a known application protocol. Uncompromised sessions involving this application on the host would have characteristics that reflect those properties. However, a host session involving an intruder, such as the intruder using Host A, will typically reflect a measurable difference in one or more key session characteristics, as compared to other sessions involving the host. By cross-comparing a host's sessions, compromise can be detected, or negated.

An analysis of Host C (on Port 25) illustrates this type of host-analysis. Host C is an SMTP listening port 25, which is an email server. As noted above, Host C is engaged in a session with Host B that results in a number of session rule violations. Whether the session-analysis findings reveal a compromise may be further confirmed by a host analysis on Host C.

The host analysis technique is particularly helpful in eliminating or reducing false positives identified in a session analysis. For example, a session may be identified as interactive even if the interactivity arises from an error or other function in the network not associated with a compromise. Such a case may arise, for example, if an instant messenger port is blocked by a network's firewall, and a client connects to web server port 80, which is typically not interactive, to conduct instant messaging sessions. In that case, the particular instant messaging session on web server port 80 would be identified as session rule violation (interactive, where non-interactive protocol is expected) but not because of a compromise. To avoid or reduce false positives, a user may analyze the session information from multiple sessions involving a particular host (e.g., Host B) and compare such characteristics amongst other sessions involving that host to identify aberrant sessions. In another aspect, the host analysis is performed by monitoring a host's session information profile as it changes over time.

As noted in Table 1, a host's role typically changes little over time, whereas the function of a compromised host may change (e.g., sessions between Host B and Host C are more interactive as intruder Host A uses Host B to access other sites and conduct other activities on network (1)). Moreover, the changes may not result in constant behavior even if the intruder uses the host regularly. Monitoring a host's sessions over time allows for detection of compromises.

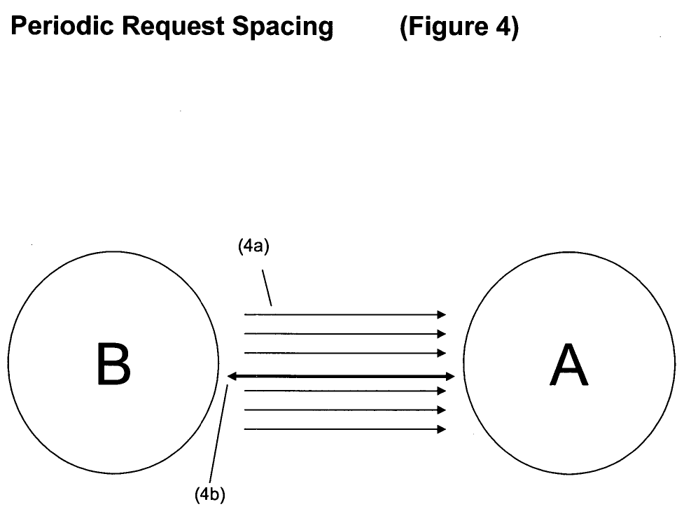

To further illustrate, the host analysis may be applied to Host B, monitoring the function of Host B over time. As shown in FIG. 4, Host B sends out periodic, failed requests to connect to a host, as represented by the unidirectional arrows in FIG. 4 (e.g., 4a). However, one attempt has succeeded (4b). A host that sends out repeated requests to connect to another host that are largely rejected but occasionally connect (a Periodic Request Spacing) is indicative of a host operating outside its expected role, a host rule violation. When applying this analysis to the findings above with respect to sessions involving Host B, it is seen that Host B only connects periodically with A, and that the sessions involving A and B result in the violations identified above. The systems and methods would accordingly report that Host B most likely functions as a locus for a reverse tunnel, which remains accessible to Host A to enter and exit the network (1) at will. The information described by Zhan and Paxson (“Detecting Backdoors”) may be employed to assist in the identification of interactive backdoors.

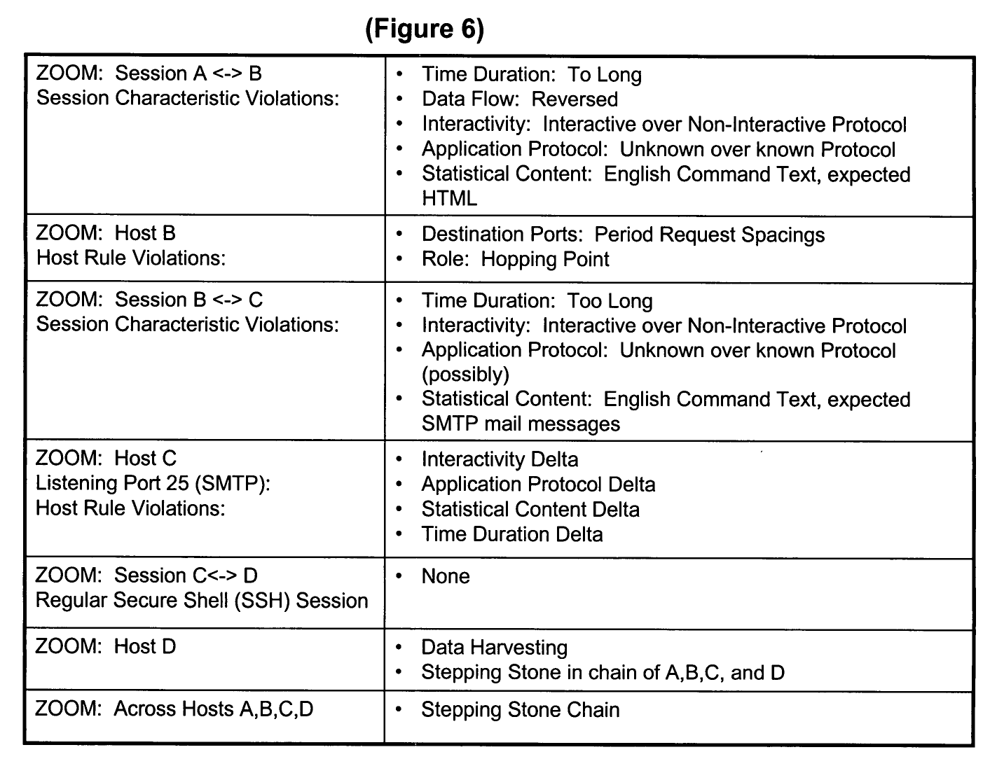

Further host or environmental analysis may be applied to reduce or eliminate false-positives or false negatives from host-level analyses. As noted above, FIG. 1 reveals that extensive data is being downloaded by Host D from Hosts E-G. In this case there is potential for false-positives if Host D were a back-up data server, as is often used by an organization to periodically gather and store network data. Such servers engage in long sessions and extract extensive data during such periods. To eliminate a false positive of this type, additional host rule violations involving the Host D are sought. That is, Host D is analyzed in the context of its relationships with other hosts, and other host rule violations are obtained. Here, similar to the analyses above for Host B and C, mirrored sessions are identified between Host D and Host E-G, confirming that Host D is a “hopping point” in a chain between Host C and Hosts E-G. Thus, Host D is not a back-up server, and the compromise may be reported. The identification completes the chain that identifies the intruder Host A's activity on the network (1). A summary of findings of the analysis of network (1) is set forth in FIG. 6.

In certain embodiments other types of holistic analyses may be applied to reduce false negatives and/or false positives, and thereby validate results. For example, where an analysis (e.g., a session analysis) reveals a host engaging in behavior in violation of session rules, the data packets may be analyzed to ascertain whether similar types of violative behavior are occurring on other hosts within the network that do not communicate directly with the identified host. As another example, where rule violations are identified through a particular analysis level among disparate hosts that do not communicate together, the timing of the violations may be compared to ascertain whether, despite the lack of direct communication between the hosts, the violations are coordinated and therefore indicative of a compromise.

Once a network analysis is performed at desired levels and, if desired, validated, a score and a report may be provided. As shown in FIG. 2, the methods and systems may be applied to independently identify violations of session rules, violations of host rules, and violations of the environmental rule, and as described above validation studies may be performed to validate results. In certain embodiments the results of each line of inquiry may be combined to provide an overall compromise score to the particular network. To this end a confidence table may be maintained to tally findings from each level of analysis.

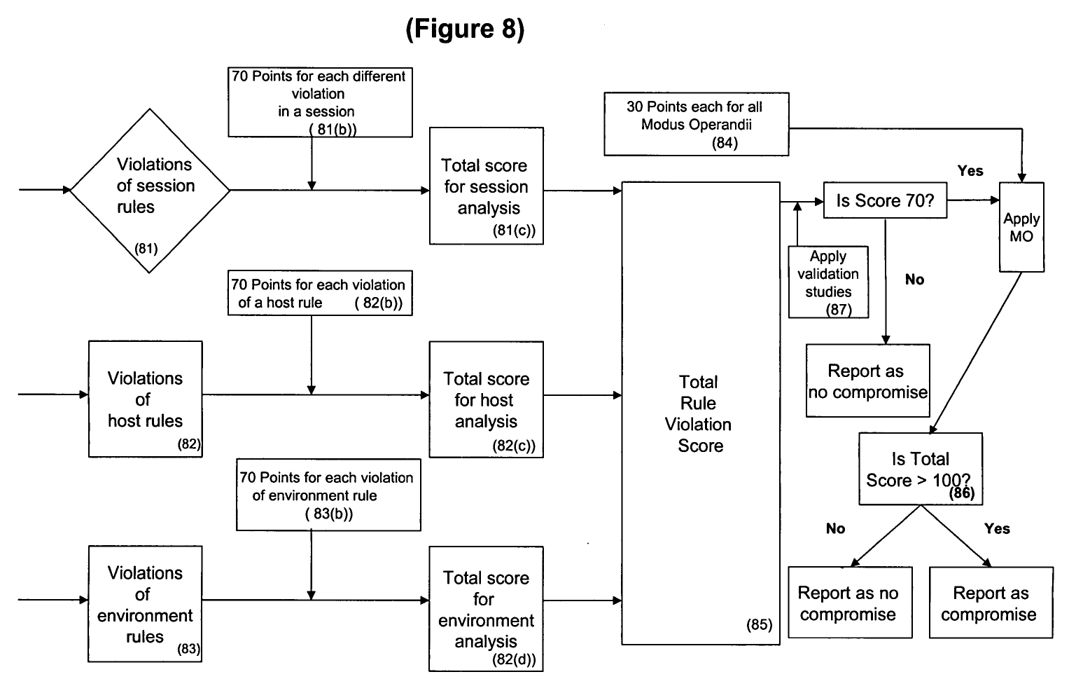

The confidence table for an exemplary analysis is described more fully in FIG. 8. Results of the session analysis in FIG. 2 are compiled and logged in tab 81, similarly results of host analysis are logged in tab 82, results of environmental analysis are set forth in tab 83, and results of M.O. analysis are set forth in tab 84. Each of the rule analysis lines may be scored independently, such that a score may be generated based solely on the results of the session analysis, based solely on the host analysis, based solely on the environmental analysis, or on combinations of the foregoing. In certain embodiments, more than one session violation for a given session is required in order to add a session violation to the confidence table. Typically, M.O. findings may be considered but are not sufficient, without identifying one or more rule violations, to warrant reporting a compromise.

As shown in FIG. 8, a score of ‘70’ is given to each identified rule violation (81b, 81c, and 81d). If a session rule violation is found, then a score of 70 is ascribed. If two session rules are violated in a given session, then the attributed score is 140, etc. If at least one rule violation is found, such that the rule violation total score (85) is greater than 0, then the network may be analyzed according to various validation studies (87) as described herein. After validation, if the score exceeds 0, an M.O. analysis is included and a score of ‘30’ (84) is applied to each finding. A total score (86) is generated and reported as desired.

In certain embodiments, the methods may be adapted to require multiple session rule violations before adding such violations to the score (81c). If the total score (86) exceeds 100 (that is, if more than one rule violation is found, or a rule violation plus multiple findings of M.O. are found) then a compromise may be reported. The scoring system may be adapted to the network; the numbers attributable to the scoring are chosen as desired to achieve sensitivity in reporting. Typically, the more rule violations identified the more likely it is that a compromise has occurred. In certain embodiments, a compromise may be reported if multiple session rule violations occur in a given session, or if multiple session rules occur and one or more host rule violations occur. In certain embodiments a compromise may be reported if multiple session rule violations occur and the environment rule is violated for a particular host. In certain embodiments, a compromise may be reported if at least one rule violation exists. In certain embodiments a compromise may be reported if rule violations occur at the host and environment levels.

It is to be understood that while the invention has been described in conjunction with the detailed description thereof, the forgoing description is intended to illustrate and not limit the scope of the invention, which is defined by the scope of the appended claims. For example, a variety of systems and/or methods may be implemented based on the disclosure and still fall within the scope of the invention. Other aspects, advantages, and modifications are within the scope of the following claims.

1. A method for detecting a compromised host in a network, comprising:
identifying hosts on a network,
identifying model session rules expected to be followed during sessions in which one or more host participates,
monitoring data packet transmissions between hosts to identify violations of the model session rules, and
identifying a compromise if at least one violation is identified in a session involving a host.

2. The method of claim 1, wherein the at least one violation includes two or more violations.

3. A method for detecting a compromised host in a network, comprising:
identifying hosts on the network,
identifying model host rules of expected operation for one or more hosts within the network,
monitoring data packet transmissions involving a host to identify violations of the model host rules, and
identifying a compromise if at least one violation of the model host rules is identified.

4. A method for detecting a compromised host in a network, comprising:
collecting data packet transmissions involving hosts on the network,
identifying model session rules expected to be followed during sessions involving the hosts,
for each host identifying model host rules of expected operation for the host and an environment rule for the host,
using the data packet transmissions to identify violations of the model session rules, model host rules, and model environment rules, and
identifying a compromise if the host is involved in at least one rule violation.

5. The method of claim 4, wherein a compromise is identified if the host is involved in more than one rule violation.

6. The method of claim 4, wherein the network is an internal network.

7. The method of claim 4, further comprising providing a report setting forth one or more identified violations.

8. The method of claim 4, further comprising analyzing the data packet transmissions to identify other communication typical of an intruder.

9. The method of claim 4, wherein a violation of a host rule includes a host changing roles on a network.

10. The method of claim 4, wherein a violation of the environment rule includes participating in one or more mirrored sessions.

11. The method of claim 4, wherein the host is a server, client, or network device.

12. The method of claim 4, wherein the host is operated by a malicious insider.

13. The method of claim 4, wherein the compromise is caused by a party that has gained unauthorized accessed to the network.

14. The method of claim 4, further comprising monitoring data packets sent and data packets received by a host through the network after identifying the host as being compromised.

15. The method of claim 4, wherein network communications are monitored at a single source on the network.

16. A method of reducing false positive results when identifying a network compromise, comprising:
monitoring data packet transmissions between hosts on a network,
identifying model session rules expected to be followed during sessions involving the hosts,
identifying model host rules of expected operation for the hosts,
using the data packet transmissions to identify violations of the model session rules,
using the data packet transmissions to identify violations of the model host rules, and
identifying a compromise if a particular host is involved in at least one rule violation.

17. The method of claim 16, wherein a compromise is identified if the particular host is involved in more than one rule violation.

18. The method of claim 16, further comprising identifying a model environment rule for each host and using the data packet transmissions to identify violations by a host of its model environment rule.

19. The method of claim 18, further comprising using the data packet transmissions to identify instances where a host engages in communication typical of an intruder.

20. The method of claim 19, wherein a compromise is detected if the host is either involved in more than one rule violation or is involved in one rule violation along with communication typical of an intruder.

21. The method of claim 19, wherein the communication typical of an intruder includes one or more of IRC Traffic, ICMP Routing, IDS Evasion and software known to be used by malicious users.

22. The method of claim 1, wherein monitoring data packet transmissions includes using a tap or span port to copy data packets transmitted on the network, bundling the copied data packets into groups based on network protocol identified in the data packet headers, associating the data packets in the groups according to unique sessions in which the data packets were transmitted.

23. The method of claim 22, further comprising compiling a profile of session information for each host on the network based on the data packets transmitted in the sessions.

24. A method for repairing a network having a compromised host, comprising
identifying a compromised host by the method of claim 4,
stopping network traffic in and out of the compromised host, and
allowing all uncompromised hosts on the network to continue functioning without interruption.

25. A method for validating a detected compromise on a network, comprising:
applying the method of claim 1 to identify a host involved in a session that violates a model session rule,
identifying model host rules of expected operation for the host,
analyzing the data packet transmissions involving the host to identify violations of the model host rules, and
validating an identified compromise if at least one violation of the model host rules is identified.

26. A method for validating a detected compromise on a network, comprising:
applying the method of claim 1 to identify a host involved in a session that violates a model session rule,
identifying a model environment rule for the host,
analyzing the data packet transmissions involving the host to identify violations of the model environment rule, and
validating an identified compromise if at least one violation of the model environment rule is identified.

27. A method for identifying a compromised network, comprising applying the method of claim 1 or claim 4, and applying validation studies to reduce at least one false positive, identify at least one false negative, or both.

28. A system for detecting a compromised network, comprising:
a data monitoring device adapted to collect data packet transmissions on a network,
software programmed with model session rules expected to be followed during sessions involving hosts on the network and with rules for operation of a model host expected to be followed by one or more hosts on the network, and
a data analysis engine operably connected to the data monitoring device and the software, and adapted to analyze the data packet transmissions to identify a network host participating in a session with one or more session rule violations.

29. The system of claim 28, wherein the data analysis engine is adapted to analyze the data packet transmissions to identify a network host violating at least one rule of operation of a model host.

30. The system of claim 29, wherein the software is further programmed with a model environment rule for each host, and the data analysis engine is adapted to analyze the data packet transmissions to identify a host operating in violation of its model environment rule.

31. The system of claim 28, further comprising a reporting unit.
